(19) United States
(12) Patent Application Publication
(10) Pub. No.: US 2008/0219000 A1
(43) Pub. Date: Sep. 11, 2008

(54) Lampshade with at least one LED

(76) Inventor: Chen-Yueh Fan, Taipei (TW)

Correspondence Address: Hershkovitz & Associates, LLC, 2845 Duke Street, Alexandria, VA, 22314, US

(21) Appl. No.: 11/715,936

(22) Filed: Mar. 9, 2007

(51) Int. Cl. F21V 1/00

(52) U.S. Cl. 362/241

(57) ABSTRACT

A lampshade with at least one LED has a circuit card, at least one LED and a reflector. The at least one LED is attached to the circuit card. The reflector is mounted around the circuit card and has at least one recess corresponding to the LED. Each recess has a reflecting sidewall to reflect light emitting from the LED. When the LED is lighting, the light is reflected via the reflecting sidewall to reflect light of the LEDs to all directions. Therefore, the brightness in all directions of the lampshade is enhanced.

### BACKGROUND OF THE INVENTION

1. Field of the Invention

The present invention relates to a lampshade with at least one LED, and more particularly to a lampshade that can reflect light provided by the LED.

2. Description of the Related Art

Tungsten bulbs provide enough light to all directions to illuminate surroundings. However, tungsten bulbs use very much electricity so LEDs are substituted for the tungsten filament lamps.

The LEDs also provide light in al directions including forward and other directions. Nevertheless, light of the LEDs radiated in other directions is much weaker than light radiated to the front of the LEDs. Thus, light radiated from LEDs except to the front is not adequate.

Therefore, the invention provides lampshade with at least one LED to mitigate or obviate the aforementioned problems.

### SUMMARY OF THE INVENTION

The main objective of the present invention is to provide a lampshade with at least one LED, and more particularly to a lampshade that reflects light emitting from the LED to enhance light in all directions.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a lampshade with at least one LED in accordance with the present invention;

FIG. 2 is a perspective view of a lampshade with at least one LED in FIG. 1;

FIG. 3 is a bottom view of the lampshade with at least one LED in FIG. 1;

FIG. 4 is a side view in partial section of the lampshade with at least one LED in FIG. 1;

FIG. 5 is a perspective view of the lampshade with at least one LED in FIG. 1 with the shell;

FIG. 6 is a perspective view of the lampshade with at least one LED in FIG. 1 with the shell and the pole;

FIG. 7 is a bottom view of the lampshade with at least one LED in FIG. 1 with the shell and the pole; and

FIG. 8 is a side view in partial section of the lampshade with at least one LED in FIG. 1 with the shell and the pole.

### DETAILED DESCRIPTION OF THE PREFERRED EMBODIMENT

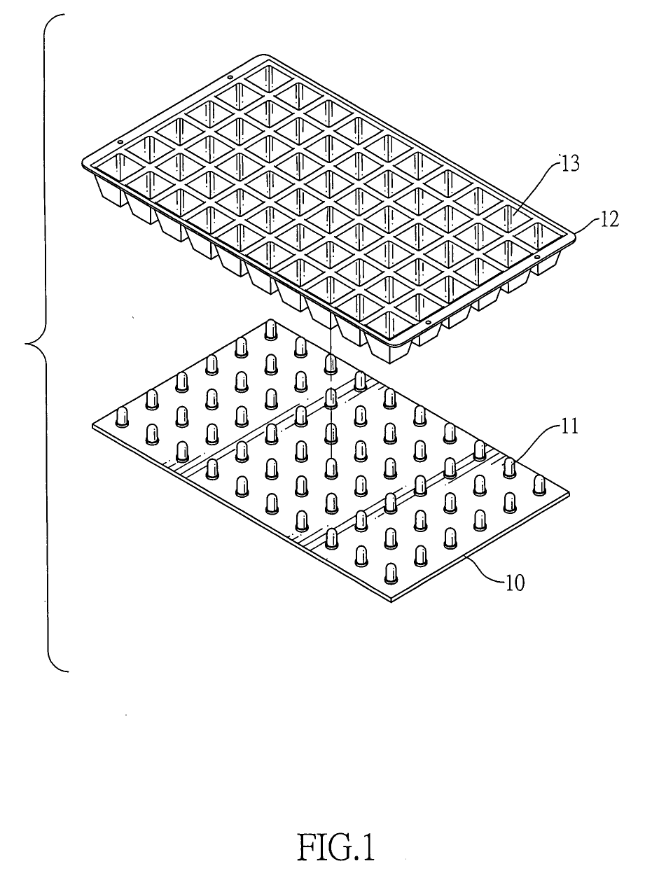

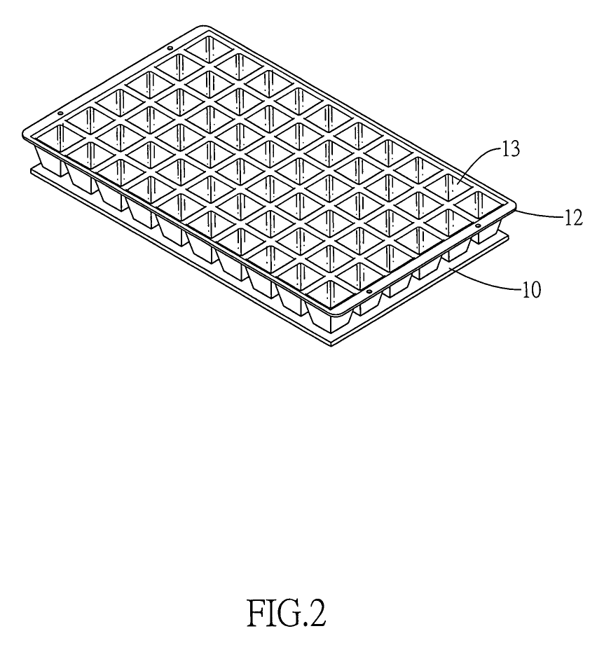

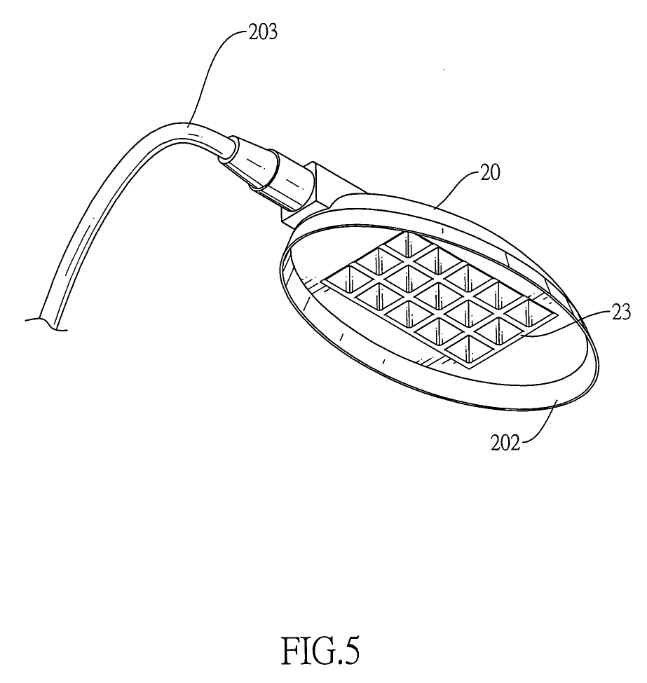

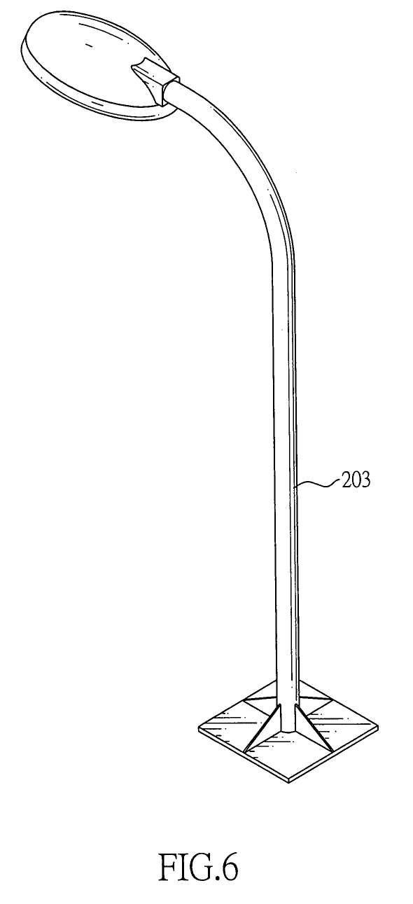

With reference to FIGS. 1, 2, 5 and 6, a lampshade with at least one LED in accordance with the present invention has a circuit card (10, 21), at least one LED (11, 22), a reflector (12, 23), a shell (20) and a pole (203).

Each one of the at least one LED (11, 22) is attached to the circuit card (10, 21).

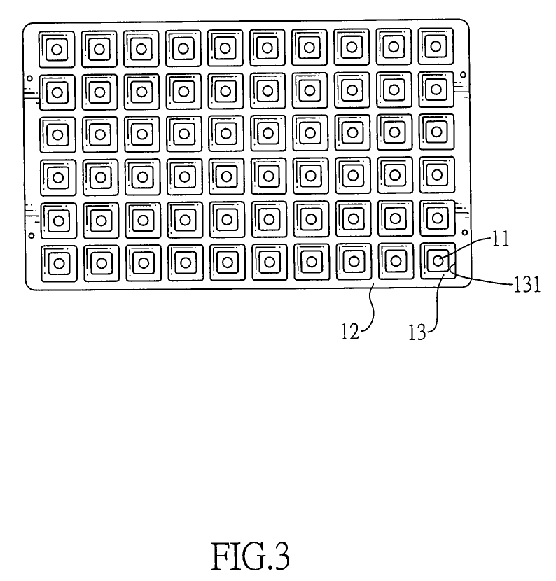

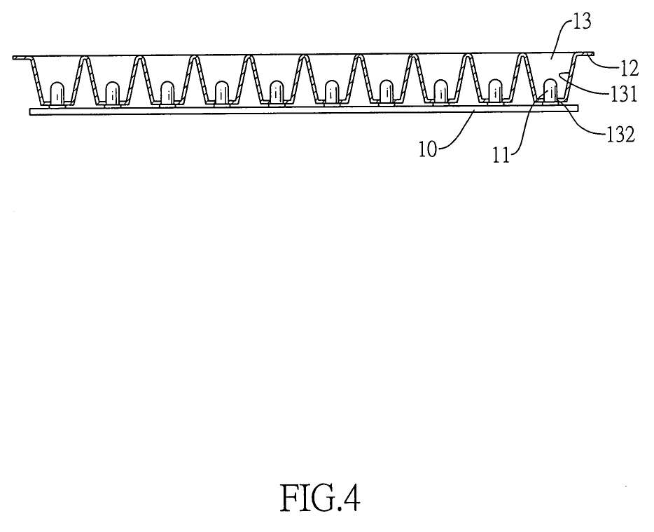

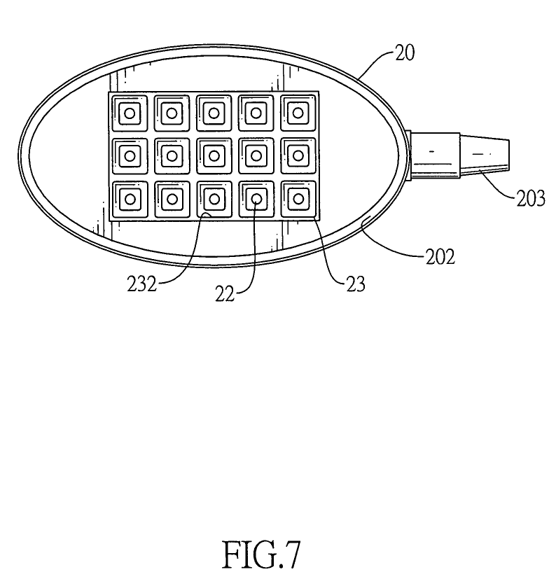

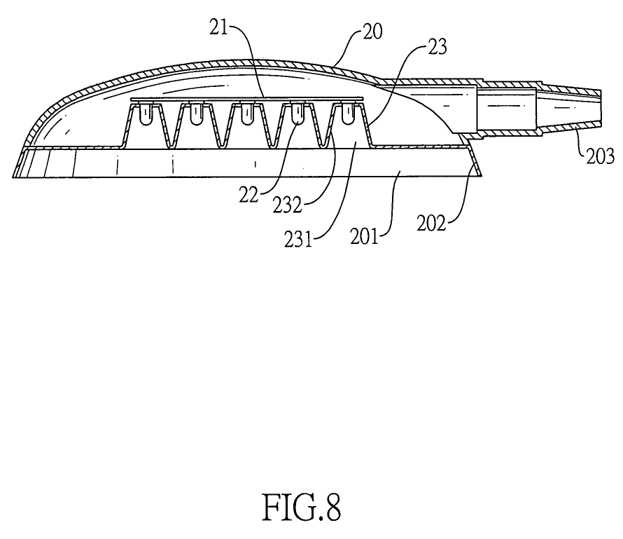

With further reference to FIGS. 3, 4, 7 and 8, the reflector (12, 23) covers the at least one LED (11) and has at least one recess (13, 231). In the preferred embodiment, the reflector (12, 23) has multiple recesses (13, 231) arranged in matrix. Each one of the at least one recess (13, 231) is formed in the reflector (12, 23) and corresponds to and is mounted around a corresponding LED (11, 22). Each one of the at least one recess (13, 231) has a bottom end, a first reflecting sidewall (131, 232) and a hole (132). The bottom end of the recess (13, 231) is a reflecting surface. The hole (132) is formed through the bottom end of the recess (13, 231) and the is inserted by the corresponding LED (11, 22).

The shell (20) has a chamber (201), a second reflecting sidewall (202) formed with the chamber (201), a pole (203) connected to the shell (20). The pole (203) enables the shell (20) to be put in a desired position.

The chamber (201) is mounted with the circuit card (21), the LED (22) and the reflector (23) in turn.

Hence, with the reflecting sidewall (131), the LED is characterized with area lamp source transferred from the point lamp source to strengthen the light thereof.

When the LED (11, 22) is lighting, light is reflected via the first and the second reflecting sidewall (131, 232, 202) to reflect light of the LEDs (11, 22) to all directions. Therefore, the brightness in all directions of the lampshade with at least one LED in accordance with the present invention is enhanced.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A lampshade with at least one LED comprising:
a circuit card;
at least one LED attached to the circuit card;
a reflector covering the at least one LED and having at least one recess, wherein each one of the at least one recess is formed in the reflector, corresponds to and is mounted around a corresponding LED and having
a bottom end;
a first reflecting sidewall; and
a hole formed through the bottom end of the recess and inserted by the corresponding LED.

2. The lampshade with at least one LED as claimed in claim 1 further comprising a shell having a chamber, wherein the circuit card, the at least one LED and the reflector are mounted in the chamber in turn.

3. The lampshade with at least one LED as claimed in claim 2, wherein the reflector has multiple recesses arranged in matrix.

4. The lampshade with at least one LED as claimed in claim 3, where the bottom ends of the recesses of the reflector are reflecting surfaces.

5. The lampshade with at least one LED as claimed in claim 4, wherein the shell has a second reflecting surface formed with the chamber.

6. The lampshade with at least one LED as claimed in claim 5 further comprising a pole connecting to the shell.
